(19) United States
(12) Patent Application Publication
(10) Pub. No.: US 2011/0060859 A1
(43) Pub. Date: Mar. 10, 2011

(54) Host-to-host software-based virtual system

(76) Inventors: Rishabhkumar Shukla, Scottsdale, AZ (US); David A. Daniel, Scottsdale, AZ (US); Koustubha Deshpande, Scottsdale, AZ (US)

(21) Appl. No.: 12/804,489

(22) Filed: Jul. 22, 2010

Related U.S. Application Data
(63) Continuation-in-part of application No. 12/802,350, filed on Jun. 4, 2010.
Application No. 12/802,350 is a continuation of application No. 12/148,712, filed on Apr. 21, 2008, now Pat. No. 7,734,859.
Application No. 12/148,712 is a continuation-in-part of application No. 12/286,796, filed on Oct. 2, 2008.
Application No. 12/286,796 is a continuation-in-part of application No. 12/655,135, filed on Dec. 23, 2009.
(60) Provisional application No. 61/271,529, filed on Jul. 22, 2009.

(51) Int. Cl. G06F 13/36; G06F 9/455

(52) U.S. Cl. 710/314; 718/1

(57) ABSTRACT

A means for extending the Input/Output System of a host computer via software-centric virtualization. Physical hardware I/O resources are virtualized via a software-centric solution utilizing two or more host systems. The invention advantageously eliminates the host bus adapter, remote bus adapter, and expansion chassis and replaces them with a software construct that virtualizes selectable hardware resources located on a geographically remote second host making them available to the first host. One aspect of the invention utilizes 1 Gbps-10 Gbps or greater connectivity via the host systems existing standard Network Interface Cards (NIC) along with unique software to form the virtualization solution.

### CLAIM OF PRIORITY

This application is a continuation-in-part of U.S. patent application Ser. No. 12/802,350 filed Jun. 4, 2010 entitled VIRTUALIZATION OF A HOST COMPUTER'S NATIVE I/O SYSTEM ARCHITECTURE VIA THE INTERNET AND LANS, which is a continuation of U.S. Pat. No. 7,734,859 filed Apr. 21, 2008 entitled VIRTUALIZATION OF A HOST COMPUTER'S NATIVE I/O SYSTEM ARCHITECTURE VIA THE INTERNET AND LANS; is a continuation-in-part of U.S. patent application Ser. No. 12/286,796 filed Oct. 2, 2008 entitled DYNAMIC VIRTUALIZATION OF SWITCHES AND MULTI-PORTED BRIDGES; and is a continuation-in-part of U.S. patent application Ser. No. 12/655,135 filed Dec. 24, 2008 entitled SOFTWARE-BASED VIRTUAL PCI SYSTEM. This application also claims priority of U.S. Provisional Patent Application Ser. No. 61/271,529 entitled “HOST-TO-HOST SOFTWARE-BASED VIRTUAL PCI SYSTEM” filed Jul. 22, 2009, the teachings of which are incorporated herein by reference.

### FIELD OF THE INVENTION

The present invention relates to computing input/output (IO), PCI Express (PCIe) and virtualization of computer resources via high speed data networking protocols.

### BACKGROUND OF THE INVENTION

### Virtualization

There are two main categories of virtualization: 1) Computing Machine Virtualization 2) Resource Virtualization.

Computing machine virtualization involves definition and virtualization of multiple operating system (OS) instances and application stacks into partitions within a host system.

Resource virtualization refers to the abstraction of computer peripheral functions. There are two main types of Resource virtualization: 1) Storage Virtualization 2) System Memory-Mapped I/O Virtualization.

Storage virtualization involves the abstraction and aggregation of multiple physical storage components into logical storage pools that can then be allocated as needed to computing machines.

System Memory-Mapped I/O virtualization involves the abstraction of a wide variety of I/O resources, including but not limited to bridge devices, memory controllers, display controllers, input devices, multi-media devices, serial data acquisition devices, video devices, audio devices, modems, etc. that are assigned a location in host processor memory. Examples of System Memory-Mapped I/O Virtualization are exemplified by PCI Express I/O Virtualization (IOV) and applicant's technology referred to as i-PCI.

PCIe and PCIe I/O Virtualization

PCI Express (PCIe), as the successor to PCI bus, has moved to the forefront as the predominant local host bus for computer system motherboard architectures. A cabled version of PCI Express allows for high performance directly attached bus expansion via docks or expansion chassis. These docks and expansion chassis may be populated with any of the myriad of widely available PCI Express or PCI/PCI-X bus adapter cards. The adapter cards may be storage oriented (i.e. Fibre Channel, SCSI), video processing, audio processing, or any number of application specific Input/Output (I/O) functions. A limitation of PCI Express is that it is limited to direct attach expansion.

The PCI Special Interest Group (PCI-SIG) has defined single root and multi-root I/O virtualization sharing specifications.

The single-root specification defines the means by which a host, executing multiple systems instances may share PCI resources. In the case of single-root IOV, the resources are typically but not necessarily accessed via expansion slots located on the system motherboard itself and housed in the same enclosure as the host.

The multi-root specification on the other hand defines the means by which multiple hosts, executing multiple systems instances on disparate processing components, may utilize a common PCI Express (PCIe) switch in a topology to connect to and share common PCI Express resources. In the case of PCI Express multi-root IOV, resources are accessed and shared amongst two or more hosts via a PCI Express fabric. The resources are typically housed in a physically separate enclosure or card cage. Connections to the enclosure are via a high-performance short-distance cable as defined by the PCI Express External Cabling specification. The PCI Express resources may be serially or simultaneously shared.

A key constraint for PCIe I/O virtualization is the severe distance limitation of the external cabling. There is no provision for the utilization of networks for virtualization.

i-PCI

This invention builds and expands on applicant's technology disclosed as “i-PCI” in commonly assigned U.S. Pat. No. 7,734,859 the teachings of which are incorporated herein by reference. This patent presents i-PCI as a new technology for extending computer systems over a network. The i-PCI protocol is a hardware, software, and firmware architecture that collectively enables virtualization of host memory-mapped I/O systems. For a PCI-based host, this involves extending the PCI I/O system architecture based on PCI Express.

The i-PCI protocol extends the PCI I/O System via encapsulation of PCI Express packets within network routing and transport layers and Ethernet packets and then utilizes the network as a transport. The network is made transparent to the host and thus the remote I/O appears to the host system as an integral part of the local PCI system architecture. The result is a virtualization of the host PCI System. The i-PCI protocol allows certain hardware devices (in particular I/O devices) native to the host architecture (including bridges, I/O controllers, and I/O cards) to be located remotely. FIG. 1 shows a detailed functional block diagram of a typical host system connected to multiple remote I/O chassis. An i-PCI host bus adapter card [101] installed in a host PCI Express slot [102] interfaces the host to the network. An i-PCI remote bus adapter card [103] interfaces the remote PCI Express bus resources to the network.

There are three basic implementations of i-PCI:

1. i-PCI: This is the TCP/IP implementation, utilizing IP addressing and routers. This implementation is the least efficient and results in the lowest data throughput of the three options, but it maximizes flexibility in quantity and distribution of the I/O units. Refer to FIG. 2 for an i-PCI IP-based network implementation block diagram.

2. i(e)-PCI: This is the LAN implementation, utilizing MAC addresses and Ethernet switches. This implementation is more efficient than the i-PCI TCP/IP implementation, but is less efficient than i(dc)-PCI. It allows for a large number of locally connected I/O units. Refer to FIG. 3 for an i(e)-PCI MAC-Address switched LAN implementation block diagram.

3. i(dc)-PCI. Referring to FIG. 4, this is a direct physical connect implementation, utilizing Ethernet CAT-x cables. This implementation is the most efficient and highest data throughput option, but it is limited to a single remote I/O unit. The standard implementation currently utilizes 10 Gbps Ethernet (802.3 an) for the link [401], however, there are two other lower performance variations. These are designated the “Low End” LE(dc) or low performance variations, typically suitable for embedded or cost sensitive installations:

The first low end variation is LE(dc) Triple link Aggregation 1 Gbps Ethernet (802.3 ab) [402] for mapping to single-lane 2.5 Gbps PCI Express [403] at the remote I/O.

A second variation is LE(dc) Single link 1 Gbps Ethernet [404] for mapping single-lane 2.5 Gbps PCI Express [405] on a host to a legacy 32-bit/33 MHz PCI bus-based [406] remote I/O.

A wireless version is also an implementation option for i-PCI. In a physical realization, this amounts to a wireless version of the Host Bus Adapter (HBA) and Remote Bus Adapter (RBA).

The i-PCI protocol describes packet formation via encapsulation of PCI Express Transaction Layer packets (TLP). The encapsulation is different depending on which of the implementations is in use. If IP is used as a transport (as illustrated in FIG. 2), the end encapsulation is within TCP, IP, and Ethernet headers and footers. If a switched LAN is used as a transport, the end encapsulation is within Ethernet data link and physical layer headers and footers. If a direct connect is implemented, the end encapsulation is within the Ethernet physical layer header and footer. FIG. 5 shows the high-level overall concept of the encapsulation technique, where TCP/IP is used as a transport.

### SUMMARY OF THE INVENTION

The present invention achieves technical advantages as a system and method virtualizing a physical hardware I/O resource via a software-centric solution utilizing two or more host systems, hereafter referred to as “Host-to-Host Soft i-PCI”. The invention advantageously eliminates the host bus adapter, remote bus adapter, and expansion chassis and replaces them with a software construct that virtualizes selectable hardware resources located on a second host making them available to the first host. Host-to-Host Soft i-PCI enables i-PCI in those implementations where there is a desire is to take advantage of and share a PCI resource located in a remote host.

### BRIEF DESCRIPTION OF THE DRAWINGS

FIG. 1 shows a detailed functional block diagram of a typical host system connected to multiple remote I/O chassis implementing i-PCI;

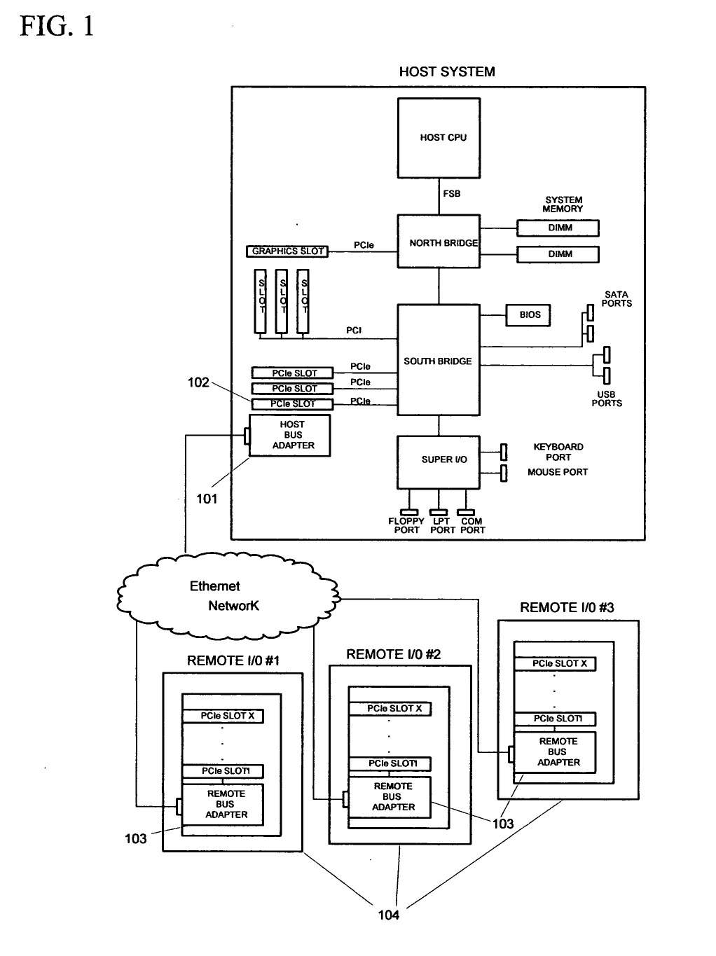

FIG. 2 is a block diagram of an i-PCI IP-based network implementation;

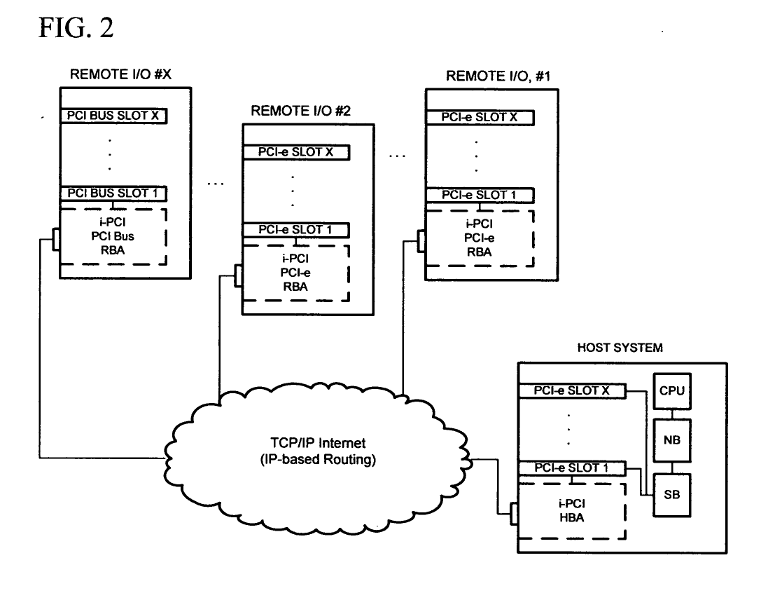

FIG. 3 is a block diagram of an, i(e)-PCI MAC-Address switched LAN implementation;

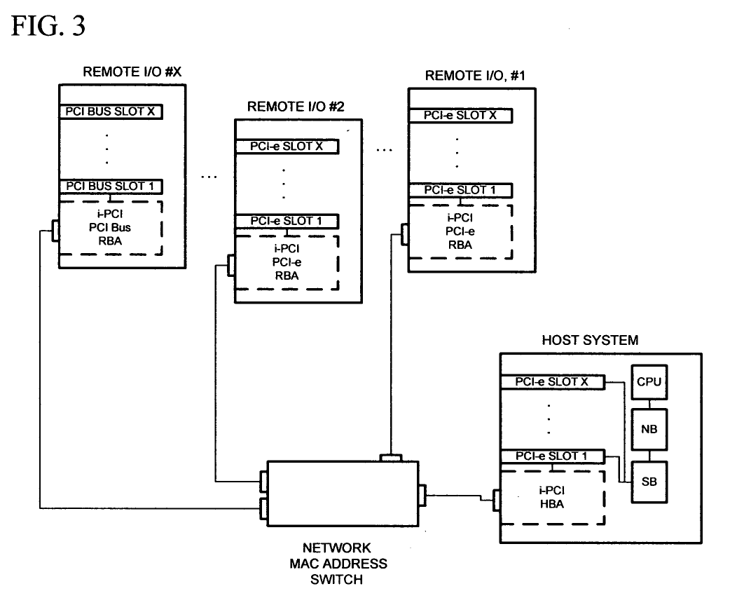

FIG. 4 is a block diagram of various direct physical connect i(dc)-PCI implementations, utilizing Ethernet CAT-x cables;

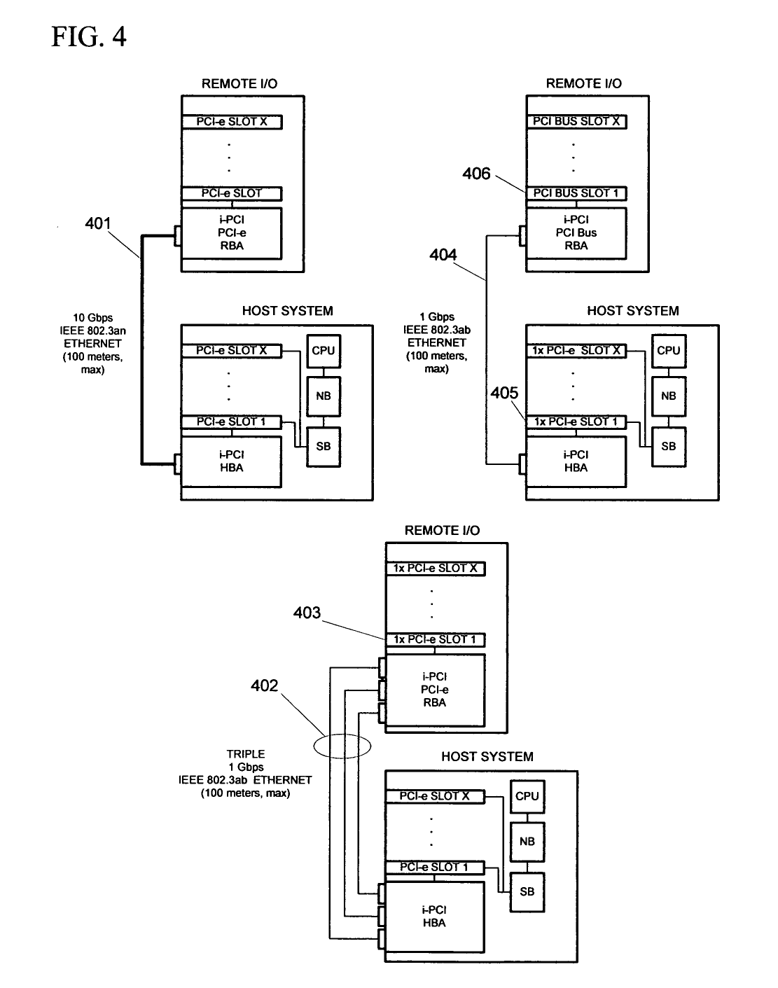

FIG. 5 is an illustrative diagram of i-PCI encapsulation showing TCP/IP used as transport;

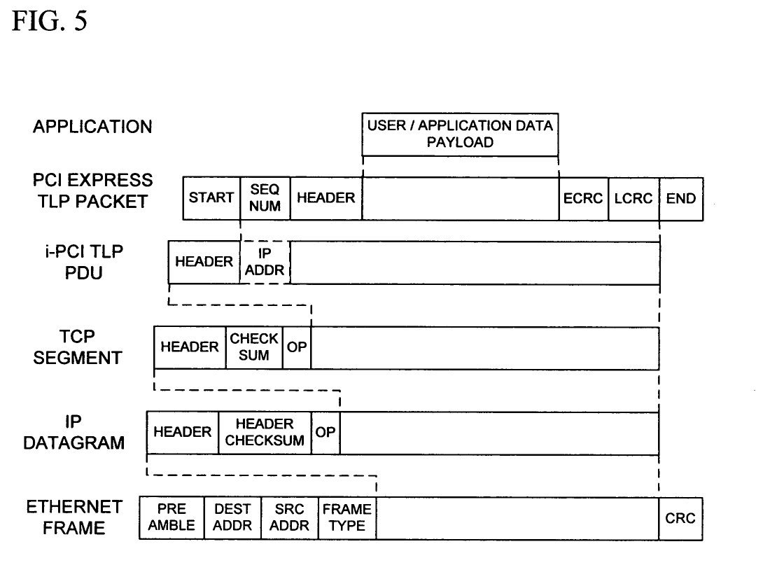

FIG. 6 is an illustration of where Soft i-PCI fits into the virtualization landscape;

FIG. 7 is a block diagram showing the PCI Express Topology;

FIG. 8 is illustration of Host-to-Host soft i-PCI implemented within the kernal space of a host system;

FIG. 9 is an illustration of Host-to-Host soft i-PCI implemented within a Hypervisor, serving multiple operating system instances;

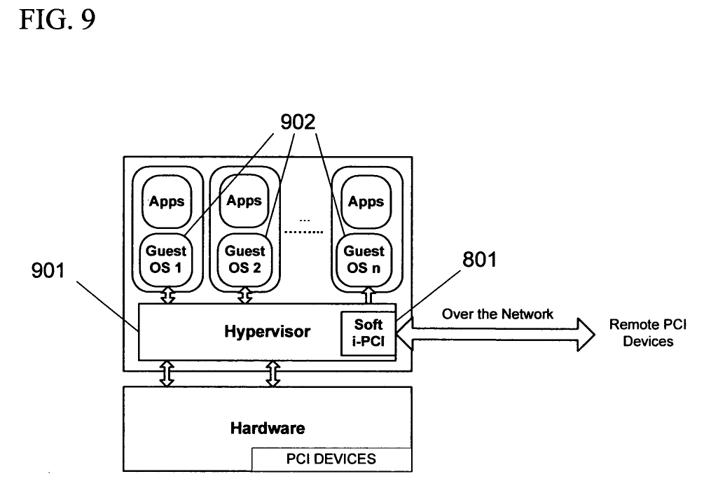

FIG. 10 shows a Host-to-Host Soft i-PCI system overview. Two computer systems, located geographically remote from each other, share a virtualized physical PCI Device(s) via a network;

FIG. 11 shows the functional blocks of Host-to-Host Soft i-PCI and their relationship to each other;

FIG. 12 is an illustration of the virtual Type 0 Configuration space construct in local memory that corresponds to the standard Type 0 configuration space of the remote shared device;

FIG. 13 is a block diagram showing a multifunction Endpoint device;

FIG. 14 is a flowchart showing the processing at Host 1 during the discovery and initialization of a virtualized endpoint device;

FIG. 15 is a flowchart showing the processing at Host 2 in support of the discovery and initialization of a virtualized endpoint device by client Host 1;

FIG. 16 is a flowchart showing the operation of the vPCI Device Driver (Front End) flow at Host 1;

FIG. 17 is a flowchart showing the operation of the vConfig Space Manager (vCM) flow at Host 1;

FIG. 18 is a flowchart showing the operation of the vResource Manager at Host 2; and

FIG. 19 is a flowchart showing the operation of the vPCI Device Driver (Back end) driver at Host 2;

### DETAILED DESCRIPTION OF THE PREFERRED EMBODIMENT

The invention advantageously provides extending the PCI System of a host computer to another host computer using a software-centric virtualization approach. One aspect of the invention currently utilizes 1 Gbps-10 Gbps or greater connectivity via the host system's existing LAN Network Interface Card (NIC) along with unique software to form the virtualization solution. Host-to-Host Soft i-PCI enables the selective utilization of one host system's PCI I/O resources by another host system using only software.

As with the solution described in commonly assigned copending U.S. patent application Ser. No. 12/655,135, Host-to-Host Soft i-PCI enables i-PCI in implementations where an i-PCI Host Bus Adapter may not be desirable or feasible (i.e. a laptop computer, an embedded design, or a blade host where PCI Express expansion slots are not available). But a more significant advantage is the fact that Host-to-Host Soft i-PCI allows one PCI host to share a local PCI resource with a second geographically remote host. This is a new approach to memory-mapped I/O virtualization.

Memory-mapped I/O virtualization is an emerging area in the field of virtualization. PCI Express I/O virtualization, as defined by the PCI-SIG, enables local I/O resource (i.e. PCI Express Endpoints) sharing among virtual machine instances.

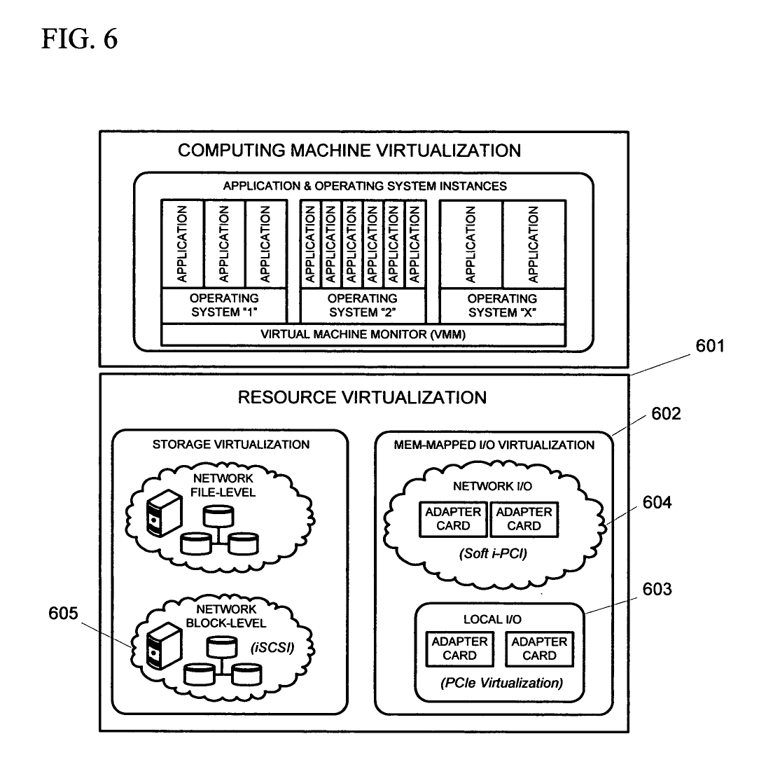

Referring to FIG. 6, Host-to-Host Soft i-PCI is shown positioned in the resource virtualization category [601] as a memory-mapped I/O virtualization [602] solution. Whereas PCI Express I/O virtualization is focused on local virtualization of the I/O [603], Host-to-Host Soft i-PCI is focused on networked virtualization of I/O [604]. Whereas iSCSI is focused on networked block-level storage virtualization [605], Host-to-Host Soft i-PCI is focused on networked memory-mapped I/O virtualization. Host-to-Host Soft i-PCI is advantageously positioned as a more universal and general purpose solution than iSCSI and is better suited for virtualization of local computer bus architectures, such as PCI/PCI-X and PCI Express (PCIe). Thus, Host-to-Host Soft i-PCI addresses a gap in the available virtualization solutions.

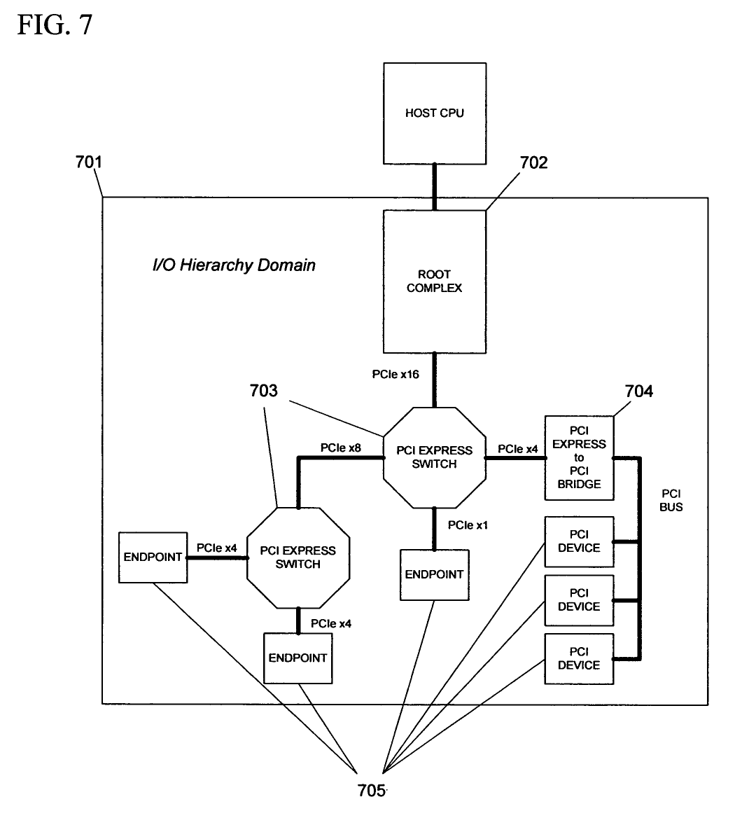

Referring to FIG. 7, the PCI Express fabric consists of point-to-point links that interconnect various components. A single instance of a PCI Express fabric is referred to as an I/O hierarchy domain [701]. An I/O hierarchy domain is composed of a Root Complex [702], switch(es) [703], bridge(s) [704], and Endpoint devices [705] as required. A hierarchy domain is implemented using physical devices that employ state machines, logic, and bus transceivers with the various components interconnected via circuit traces and/or cables. The Root Complex [702] connects the CPU and system memory to the I/O devices. A Root Complex [702] is typically implemented in an integrated circuit or host chipset (North Bridge/South Bridge).

Host-to-Host Soft i-PCI works within the fabric of a host's PCI Express topology, extending the topology, adding devices to an I/O hierarchy via virtualization. It allows PCI devices or functions located on a geographically remote host system to be memory-mapped and added to the available resources of a given local host system, using a network as the transport. Host-to-Host Soft i-PCI extends hardware resources from one host to another via a network link. The PCI devices or functions may themselves be virtual devices or virtual functions as defined by the PCI Express standard. Thus, Host-to-Host Soft i-PCI works in conjunction with and complements PCI Express I/O virtualization, extending the geographical reach.

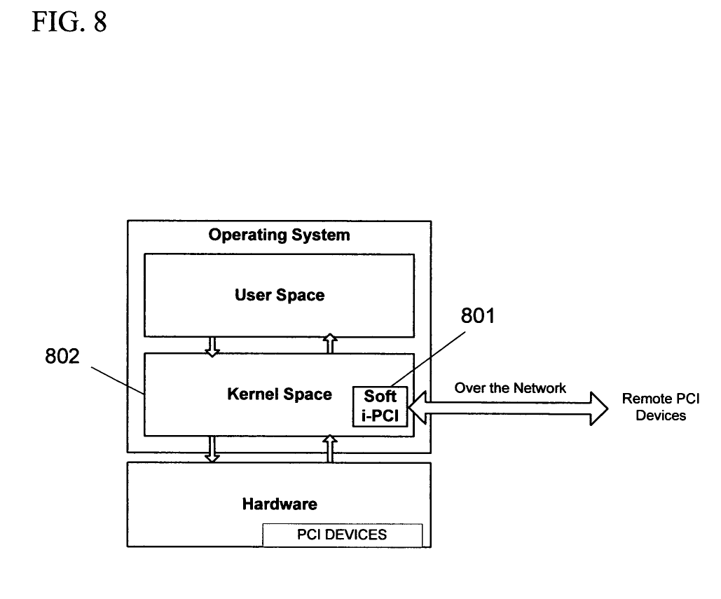

In one preferred implementation, Referring to FIG. 8, Host-to-Host soft i-PCI [801] is implemented within the kernal space [802] of each host system.

In another preferred implementation, the Host-to-Host soft i-PCI [801] is similarly implemented within a Virtual Machine Monitor (VMM) or Hypervisor [901], serving multiple operating system instances [902].

Although implementation within the kernal space or hypervisor are preferred solutions, other solutions are envisioned within the scope of the invention. In order to disclose certain details of the invention, the Host-to-Host Kernal Space implementation is described in additional detail in the following paragraphs.

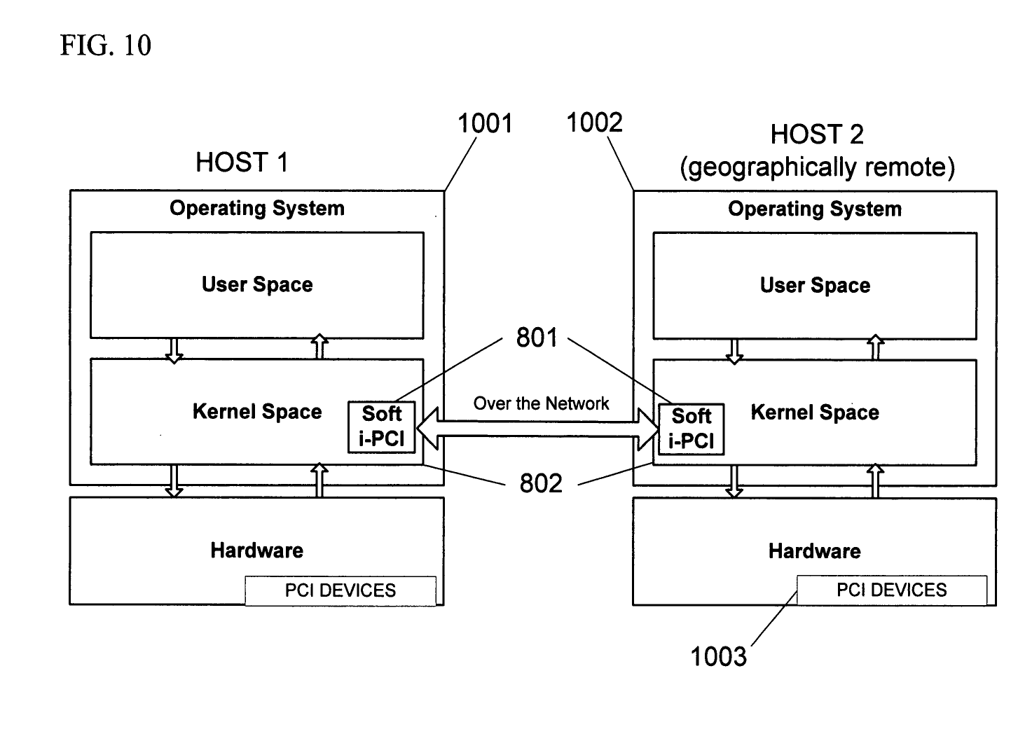

Referring to FIG. 10, Host-to-Host Soft i-PCI [801] enables communication between computer systems located geographically remote from each other and allows physical PCI Device(s) [1003] located at one host to be virtualized (thus creating virtual PCI devices) such that the device(s) may be shared with the other host via a network. Soft-iPCI becomes an integral part of the kernel spaces upon installation and enables PCI/PCI Express resource sharing capability without affecting operating system functionality. Hereafter “Host 1” [1001] is defined as the computer system requesting PCI devices and “Host 2” [1002] is defined as the geographically remote computer system connected via the network.

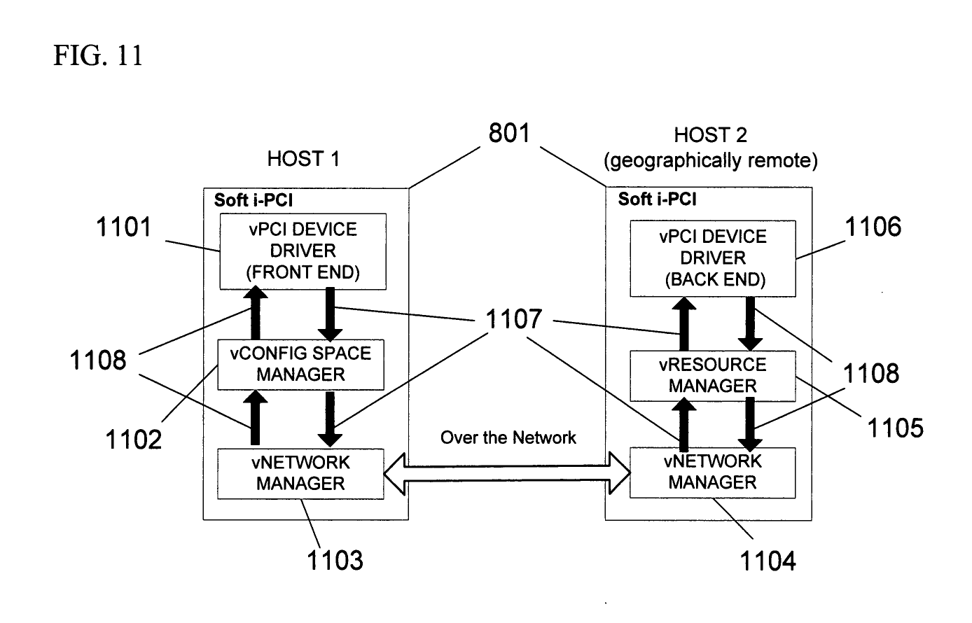

Host-to-Host Soft i-PCI [801] is a software solution consisting of several “components” collectively working together between Host 1 and Host 2. Referring to FIG. 11, the software components include the vPCI Device Driver (Front End) [1101], vConfig-Space Manager (Host 1) [1102], vNetwork Manager (Host 1) [1103], vNetwork Manager (Host 2) [1104], vResource Manager (Host 2) [1005], and vPCI Device Driver (Back End) [1106], (where ‘v’ stands for virtual interface to remotely connected devices). Two queues are defined as the Operation Request Queue [1107] and the Operation Response Queue [1108].

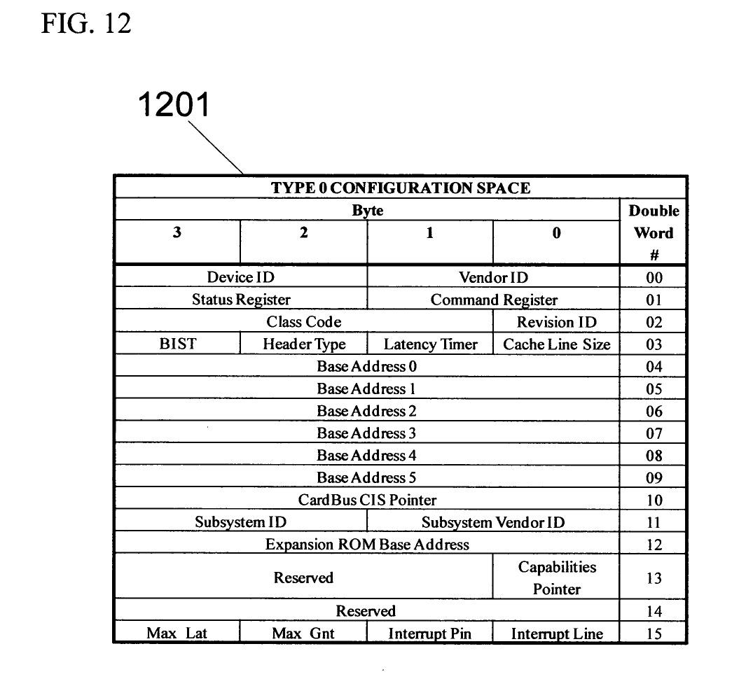

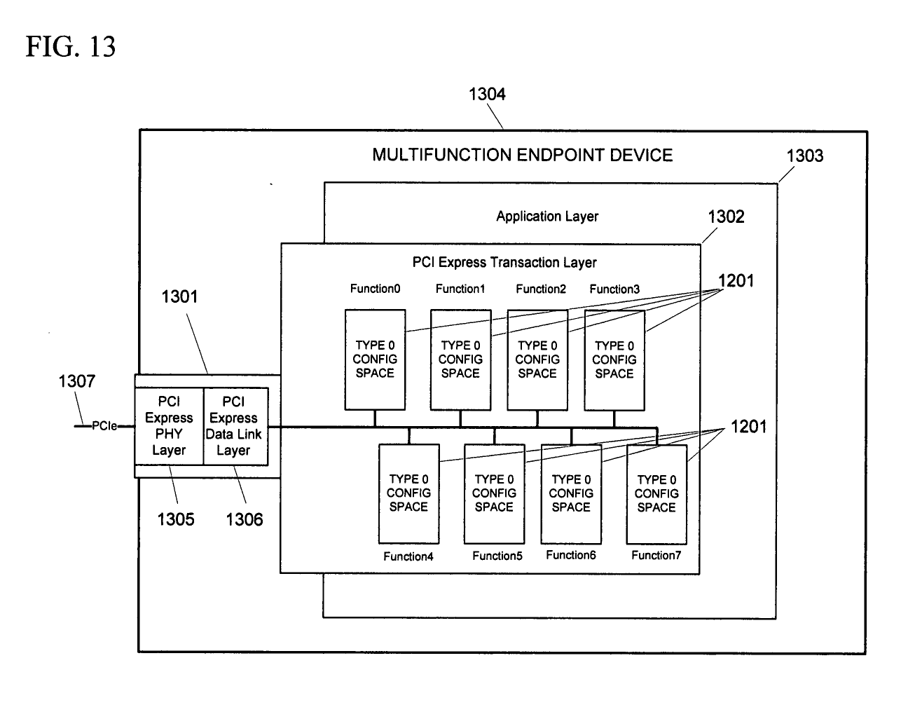

Referring to FIGS. 11, 12, and 13 the following functional descriptions are illustrative of the invention:
The vPCI Device Driver (Front End): The vPCI Device Driver (Front End) [1101] is the front end half of a “split” device driver. The Front End part interacts with the kernel in Host 1 and its primary task is to transfer the IO requests to the lower level modules which then in turn are responsible for transferring the IO requests to the back end device driver, vPCI Device Driver (Back End) [1106] located at Host 2.
The Config Space Manager (vCM): The Config Space Manager (vCM) [1102] has a variety of roles and responsibilities. During the initialization phase, vCM creates a virtual Type 0 Configuration space construct [1201] in local memory that corresponds to the standard Type 0 configuration space (as defined by the PCI SIG) associated with the particular PCI Express Endpoint device or function available for virtualizing on Host 2. It also performs address translation services and maintains a master mapping of PCI resources to differentiate between the local and remote virtual PCI devices and directs transactions accordingly.
Per the PCI Express specification, a PCI Express Endpoint Device must have at least one function (Function0) but it may have up to eight separate internal functions. Thus a single device at the end of a PCI Express link may implement up to 8 separate configuration spaces, each unique per function. Such PCI Express devices are referred to as “Multifunction Endpoint Devices”. Referring to FIG. 13, a multifunction IO virtualization enabled Endpoint is connected to a host PCI Express Link [1307] via an Endpoint Port [1303] composed of a PHY [1305] and Data Link layer [1306]. The multifunction Endpoint Port [1301] is connected to the PCI Express Transaction Layer [1302] where each function is realized via separate configuration space [1201]. The PCI Express Transaction layer [1302] interfaces to the end point Application Layer [1303], with the interface as defined by the PCI Express specification. Up to eight separate software-addressable configuration accesses are possible as defined by the separate configuration spaces [1201]. The operating system accesses a combination of registers within each function's Type 0 configuration space [1201] to uniquely identify the function and load the corresponding driver for use by a host application. The driver then handles data transactions to/from the function and corresponding Endpoint application associated with the particular configuration space, per the PCI Express specification.
Per the PCI Express specification IOV extensions, an IO virtualization enabled endpoint may be shared serially or simultaneously by one or more root complexes or operating system instances. Virtual Functions associated with the Endpoint are available for assignment to system instances. With Host-to-Host soft i-PCI, this capability is expanded. The virtualization enabled endpoint (i.e. the associated virtual functions) on Host 2 is shared with Host 1 via the network, rather than a PCI Express fabric, and mapped into the Host 1 hierarchy.
During the normal PCI I/O operation execution, the vPCI Device Driver (Front End) [1101] transfers the PCI IO operation request to The Config Space Manager (vCM) [1102] which in turn converts the local PCI resource address into its corresponding remote PCI resource address. The Config Space Manager (vCM) [1102] then transfers this operation request to vNetwork Manager (Host 1) [1103] and waits for response from Host 2.
Once the vNetwork Manager (Host 1) [1103] gets a response back from Host 2, it delivers it to the Config Space Manager (vCM) [1102]. The Config Space Manager (vCM) [1102] executes an identical operation on the local virtual device's in-memory configuration space and PCI resources. Once this is accomplished, it transfers the response to The vPCI Device Driver (Front End) [1101].

vNetwork Manager (Host 1): The vNetwork Manager [1103] at Host 1 is responsible for a high-speed, connection-oriented, reliable, and sequential communication via the network between the Host 1 and Host 2. The i-PCI protocol provides such a transport for multiple implementation scenarios, as described in commonly assigned U.S. Pat. No. 7,734,859 the teachings of which are incorporated herein by reference. The given transport properties ensure that none of the packets are dropped during the transaction and the order of operation remains unaltered. The vNetwork Manager sends and receives the operation request and response respectively from its counterpart on Host 2.

vNetwork Manager (Host 2): The vNetwork Manager at Host 2 [1104] is the counterpart of vNetwork Manager [1103] at Host 1. The vNetwork Manager (Host 2) [1104] transfers the IO operation request to the vResource Manager (Host 2) [1105] and waits for a response. Once it receives the IO operation output, it transfers it to the vNetwork Manager at Host 1 [1103] via the network.

vResource Manager (Host 2): The vResource Manager (Host 2) [1105] receives the operation request from the vNetwork Manager (Host 2) [1104] and transfers it to the vPCI device driver (Back End) [1106]. The vResource Manager (Host 2) [1105] also administers the local PCI IO resources for the virtualized endpoint device/functions and sends back the output of the IO operation to the vNetwork Manager at Host 2 [1104].

vPCI device driver (Back end): The vPCI device driver (Back end) [1106] is the PCI driver for the virtualized shared device/function hardware resource at Host-2. The vPCI device driver (Back end) [1106] performs two operations. First it supports the local PCI IO operations for the local kernel and second it performs the IO operations on the virtualized shared device/function hardware resource as requested by Host 1. The vPCI Device driver waits asynchronously or through polling for any type of operation request and goes ahead with the execution once it receives one. Second, it transfers the output of the IO operations to the vResource Manager (Host 2) [1105].

Operation Request Queue: The Operation Request Queue [1107] is a first-in-first-out linear data structure which provides inter-module communication between the different modules of Host-to-Host Soft i-PCI [801] on each host. The various functional blocks or modules, as previously described, wait asynchronously or through polling at this queue for any IO request. Once a request is received, execution proceeds and the resultant is passed on to the next module in line for processing/execution. In this entire processing, the sequence of operation is maintained and insured.

Operation Response Queue: The Operation Response Queue [1108] is similar in structure to the Operation Request Queue [1107] as previously described. However, the primary function of the Operation Response Queue [1108] is to temporarily buffer the response of the executed IO operation before processing it and then forwarding it to the next module within a host.

As a means to illustrate and clarify the invention, a series of basic flow charts are provided along with associated summary descriptions:

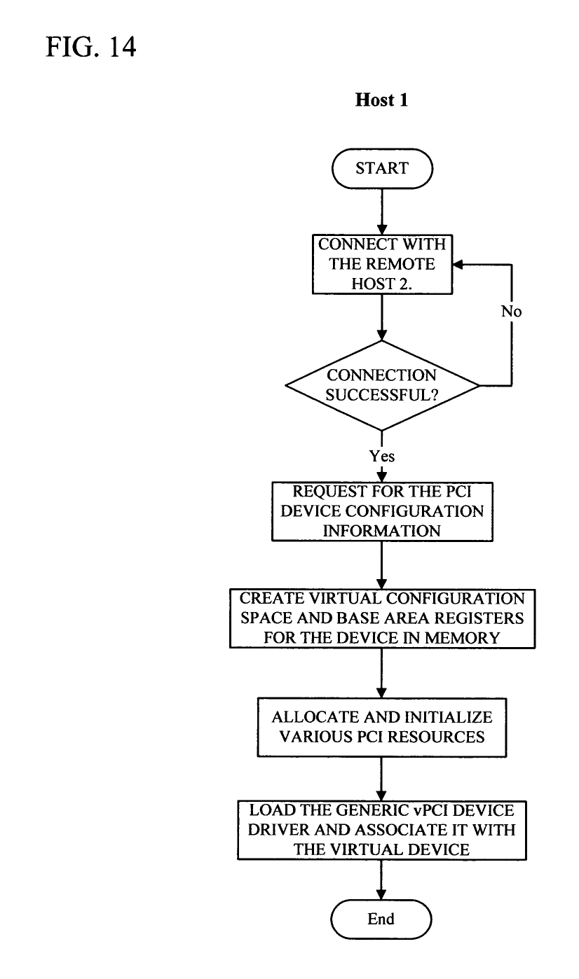

Discovery and Initialization (Host 1): Referring to FIG. 14, the initial flow at Host 1 for the discovery and initialization of a virtualized endpoint device is as follows:
Host 1 [1001] (client) attempts to connect with the Host-2 (server) [1002]. This involves establishing a connection between Host 1 and Host 2 per a session management strategy such as described for “i-PCI” in commonly assigned U.S. Pat. No. 7,734,859, the teachings of which are incorporated herein by reference. Host 1 provides a mutually agreed upon authentication along with the requested PCI device information. The connection set up as well as PCI device information is hard-coded into the system while the discovery process for the PCI device at Host 2, via the network, is dynamic.
Based on the success/failure of the connection between Host 1 and Host 2, Host 1 attempts reconnecting to Host 2 or receives the complete device information. This device information primarily contains an image of entire configuration space of the requested device along with its base area registers and other related resources which generally exist in the ROM for a given PCI device.
In the next step, the Config Space Manager (vCM) [1102] creates a mirror image of the remote device's configuration space [1201] and other resources in local memory. It also initializes and associates a memory mapped IO with this virtual configuration space. From this point forward, all access operations to the virtual configuration space [1201] are synchronized and controlled by the Config Space Manager (vCM) [1102]. This prevents any type of corruption by erroneous or corrupted IO request.
In the next step, the kernel loads the vPCI device driver (vPDD) and associates it with the virtualized PCI device. This is a basic “filter and redirect” type device driver applicable for any/all PCI devices with the primary responsibility of directing the requested IO operation to the back-end driver [1106] located geographically remote at Host 2 [1002].

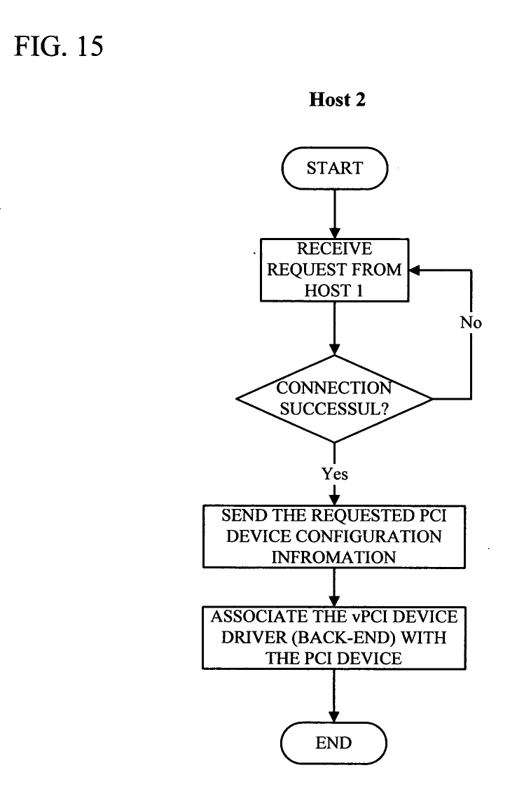

Discovery and Initialization (Host 2): Referring to FIG. 15, the initial flow at Host 2 [1002] in support of the discovery and initialization of a virtualized endpoint device by client Host 1 [1001] is as follows:
The Operating System at Host 2 [1002] is a fully-functional operating system. In its normal running mode, it receives a connection request from the Host 1. Once the initial connection setup is done and Host 1 [1001] is successfully connected with Host 2, Host 2 transfers the complete image of the configuration space [1201] for a given PCI device.
After accomplishing the configuration space transfer, the virtualized device is associated with the vPCI device driver (vPDD) which at Host 2 consists of the back end [1106] half of the split device driver.
The vPCI device driver's primary task is to filter the local IO operations from those coming from Host 1 via the network. Optionally, some of the system calls are converted to hypercalls in a manner similar to hypervisors in order to support multiple IO requests originating from different guest Operating systems.
The device shared by Host 2 is an IOV enabled Endpoint capable of sharing one or more physical endpoint resources and multiple virtual functions as defined by the PCI Express specification and extensions.

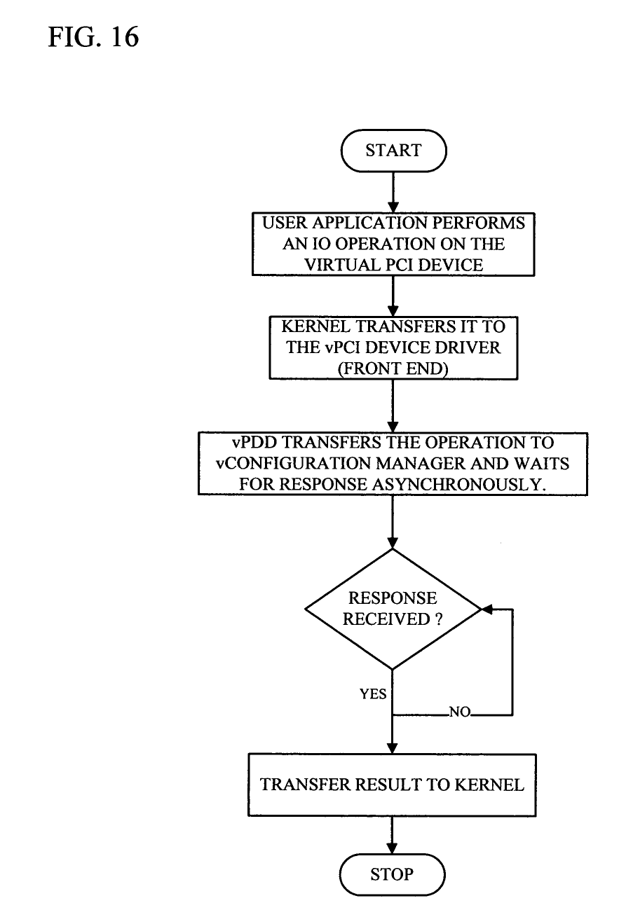

Operation of vPCI Device Driver (Front End): Referring to FIG. 16, the operation of the vPCI Device Driver (Front End) [1101] flow at Host 1 [1001] is as follows:
In the usual kernel flow, a user application request for an IO operation on a given PCI device is executed by the kernel as a system call. This ultimately calls the associated device driver's IO function. In the case of a virtual PCI device, the kernel calls the vPCI device driver [1101] for the IO operation.
The vPCI Device Driver (Front End) [1101] transfers this IO operation to the Config Space Manager (vCM) [1102] using the associated Operation Request Queue [1107]. The vPCI Device Driver (Front End) [1101] then waits for a response from the vConfig Space Manager (vCM) [1102] asynchronously or through a polling mechanism depending upon the capabilities of the native operating system.
Once a response is received from the vConfig Space Manager (vCM) [1102] via the Operation Response Queue [1108], the vPCI Device Driver (Front End) [1101] transfers the result to the kernel API which had called the IO operation.

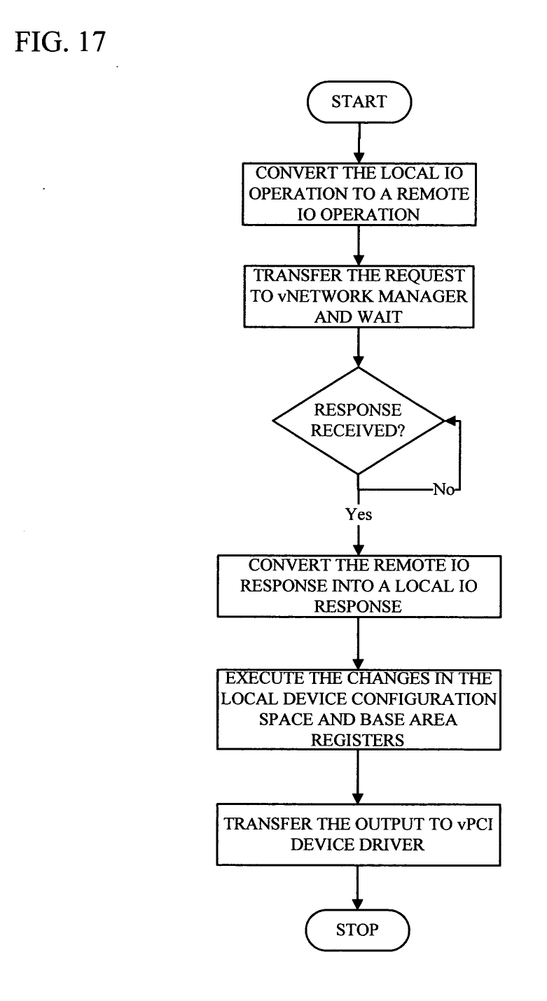

Operation of vConfig Space Manager: Referring to FIG. 17, the operation of the vConfig Space Manager (vCM) [1102] flow at Host 1 [1001] is as follows:
The vPCI Device Driver (Front End) [1101] transfers a given PCI IO operation to the vConfig Space Manager (vCM) [1102] vCM component using the associated Operation Request Queue [1107].
The vConfig Space Manager (vCM) [1102] converts the local IO operation into a remote IO operation based on the local copy of the virtualized PCI device configuration space that was created during the initialization phase. This step is required due to the fact that some of PCI resources assigned to the virtual PCI device might overlap with a local PCI device configuration space. This local to remote translation optionally utilizes the address translation services as defined by the PCI Express Specification and IOV extensions.
Once the translation is complete, the vConfig Space Manager (vCM) [1102] creates a data packet, which gives details of the particular device information, requested operation, memory area to work upon and type of operation, etc. as described for “i-PCI” in commonly assigned U.S. Pat. No. 7,734,859, the teachings of which are incorporated herein by reference.
The vConfig Space Manager (vCM) [1102] delivers the packet into the Operation Request Queue [1107] between the vConfig Space Manager (vCM) [1102] and the vNetwork Manager at Host 1 [1103] and waits asynchronously or through polling for a response from Host 2.
Once it gets a response from the vNetwork Manager (Host 1) [1103] via the Operation Response Queue [1108], The vConfig Space Manager (vCM) [1102] takes the response packet and fragments it to extract the result. At this point it performs a remote-to-local translation in a reverse fashion to that as previously described.
Once done with the translation, the vConfig Space Manager (vCM) [1102] executes the same operation on the local copy of the virtualized PCI device configuration space that was created during the initialization phase to ensure it exactly reflects the state of the memory mapped IO of the virtualized PCI device physically located at Host 2.
Once done with this configuration space synchronization, the vConfig Space Manager (vCM) [1102] transfers the result to the vPCI Device Driver (Front End) [1101] via the Operation Response Queue [1108].

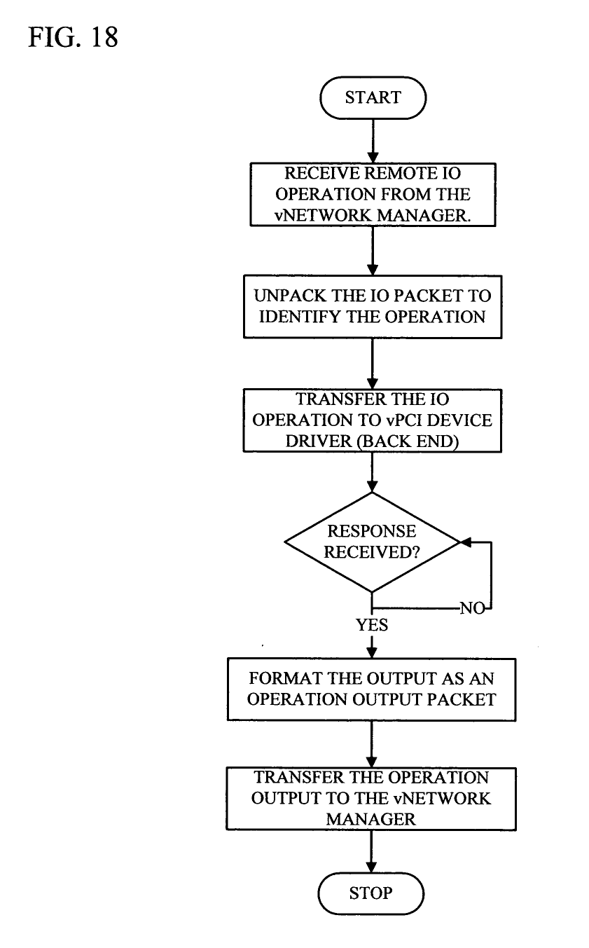

Operation of the vResource Manager: Referring to FIG. 18, the operation of the vResource Manager (Host 2) [1105] flow is as follows:
The vResource Manager (Host 2) [1105] receives the IO request from Host 1 via the vNetwork Manager (Host 2) [1104].
The vResource Manager (Host 2) [1105] then transfers this operation request to the vPCI Device Driver (Back end) driver [1106]. This results in execution of the operation on the actual physical PCI device. The vResource Manager (Host 2) [1105] waits for a response asynchronously or through a polling mechanism.
Once it gets the response from the vPCI Device Driver (Back end) driver [1106], it reformats the output as a response packet and transfers it to the vNetwork Manager (Host 2) [1104] which in turn transfers the same to vNetwork Manager (Host 1) [1103] via the network.

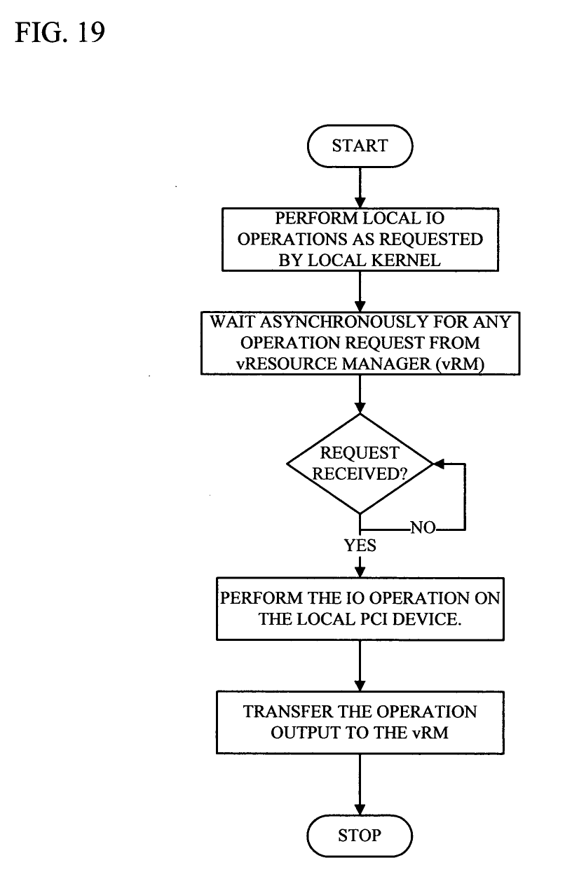

Operation of the vPCI Device Driver (Back end) driver [1106]. Referring to FIG. 19, the operation of the vPCI Device Driver (Back end) driver [1106] flow is as follows:
The vPCI Device Driver (Back end) driver [1106] performs two primary operations: 1) It provides regular device driver support for any local IO operations at Host 2 [1002]. 2) It executes any Host-to-Host Soft i-PCI virtual IO operations as requested by the originating kernel on Host 1. It receives these operations via the vResource Manager (Host 2) [1105].
In its normal execution, the vPCI Device Driver (Back end) [1106] executes the IO requests as generated by the local kernel at Host 2. Simultaneously, it also keeps polling or waits asynchronously to check if it has got any IO request from Host 1 via the vResource Manager (Host 2) [1105].
Once the vPCI Device Driver (Back end) driver [1106] gets an IO operation request from the vResource Manager (Host 2) [1105], it performs the operation on the actual physical PCI device and transfers the result to the vResource Manager (Host 2) [1105], which in turn transfers it to the vNetwork Manager (Host 2) [1104].

Though the invention has been described with respect to a specific preferred embodiment, many variations and modifications will become apparent to those skilled in the art upon reading the present application. The intention is therefore that the appended claims be interpreted as broadly as possible in view of the prior art to include all such variations and modifications.

What is claimed is:

1. An input/output (IO) resource virtualization system, comprising
a first host having a CPU and an operating system;
a first module operably coupled to the first host CPU and operating system, the first module configured to provide one or more virtual IO resources via a network transport through software means;
a second host geographically remote from the first host and having a CPU and an operating system; and
a second module operably coupled to the geographically remote second host CPU and operating system, the second module configured to provide the first host with shared access, via the network transport and the first module, to one or more of the second host physical IO resources through software means.

2. The IO resource virtualization system as specified in claim 1, wherein the first module is configured to manage a PCI IO system topology such that the operating system and applications running on the first host are unaware that shared said second host physical IO resources are located at the geographically remote second host.

3. The IO resource virtualization system as specified in claim 1 wherein PCI devices or functions located on the geographically remote second host are memory-mapped as available resources of the first host via the network transport.

4. The IO resource virtualization system as specified in claim 3 wherein the PCI devices or functions are virtual devices or virtual functions as defined by the PCI Express standard.

5. The IO resource virtualization system as specified in claim 1 wherein the first module is implemented within a kernal space of the first host.

6. The IO resource virtualization system as specified in claim 1 wherein the first module is implemented within a Virtual Machine Monitor (VMM) or Hypervisor.

7. The IO resource virtualization system as specified in claim 1 wherein the first module comprises a PCI device driver, a configuration space manager, and a network manager.

8. The IO resource virtualization system as specified in claim 7 wherein the PCI device driver is configured to transfer a PCI IO operation request to the configuration space manager, which configuration space manager is configured to convert a local PCI resource address into a corresponding remote PCI resource address and then transfer the operation request to the network manager and then wait for response from the second host.

9. The IO resource virtualization system as specified in claim 8 wherein the network manager is configured to receive a response from the second host and deliver it to the configuration space manager, which configuration space manager is configured to execute an identical operation on a first host in-memory configuration space and PCI resources.

10. The IO resource virtualization system as specified in claim 1 wherein the first module comprises an operation request queue comprising a first-in-first-out linear data structure configured to provide inter-module communication between different modules on the first host.

11. The IO resource virtualization system as specified in claim 1 wherein the first module comprises an operation response queue configured to temporarily buffer a response of an executed IO operation from the second host before processing it and then forwarding it within the first host.

12. The IO resource virtualization system as specified in claim 8 wherein the second host comprises a PCI device driver, a host manager, a configuration space manager, and a network manager, wherein the host manager is configured to receive the PCI IO operation request from the first host and transfer it to the second host PCI driver.

13. The IO resource virtualization system as specified in claim 12 wherein the second host manager is configured to receive a response from the second host PCI driver and transfer it to the first host via the transport network.

14. The IO resource virtualization system as specified in claim 1, wherein the network transport comprises a network interface card (NIC).

15. The IO resource virtualization system as specified in claim 1 wherein the network transport is defined by an Internet Protocol Suite.

16. The IO resource virtualization system as specified in claim 13, wherein the network transport is TCP/IP.

17. The IO resource virtualization system as specified in claim 1, wherein the network transport is a LAN.

18. The IO resource virtualization system as specified in claim 1, wherein the network transport is an Ethernet.

19. The IO resource virtualization system as specified in claim 1, wherein the network transport is a WAN.

20. The IO resource virtualization system as specified in claim 1, where the network transport is a direct connect arrangement configured to utilize an Ethernet physical layer as the transport link, without consideration of a MAC hardware address or any interceding external Ethernet switch.
